(19) United States
(12) Patent Application Publication
(10) Pub. No.: US 2023/0359843 A1
(43) Pub. Date: Nov. 9, 2023

(54) AUTHENTICATION SYSTEM USING LIGHT EMITTER OF TRANSPORATION MEANS AND AUTHENTICATION INFORMATION PROCESSING METHOD USING THE SAME

(71) Applicant: BPLAT LLC, Seoul (KR)

(72) Inventor: Suk Hwan YEOM, Gwangju-si (KR)

(21) Appl. No.: 17/841,311

(22) Filed: Jun. 15, 2022

(30) Foreign Application Priority Data
May 6, 2022 (KR) 10-2022-0056280

(51) Int. Cl. G06K 7/14; G06F 21/44; G06Q 20/34

(52) U.S. Cl. CPC G06K 7/14; G06F 21/44; G06Q 20/353

(57) ABSTRACT

An authentication system includes a light emitter provided in a transportation means, which emits light having a predetermined emission pattern, a light receiver that receives the emission pattern of the light emitted from the light emitter to convert the emission pattern into a predetermined form of data, and an authentication server configured to receive the data converted by the light receiver and generate authentication information on the data to transmit the generated authentication information to the transportation means.

### CROSS-REFERENCE TO RELATED APPLICATION

This application claims priority from Korean Patent Application No. 10-2022-0056280 filed on May 6, 2022, which application is incorporated herein by reference in its entirety.

### BACKGROUND

### 1. Technical Field

The present disclosure relates to an authentication system using a light emitter of a transportations means and an authentication information processing method using the same, and more particularly to an authentication system with significantly improved security and safety compared to other authentication systems by generating authentication information via light emitted by a light emitter of a transportation means having a predetermined emission pattern to perform an authentication process or a payment process, and an authentication information processing method using the same.

### 2. Related Art

Recently, in-car payment systems have attracted attention. In a conventional in-car payment system, a user registers a previously issued credit card, etc. in a car system, and an in-car wireless communication module is linked and operated with a point of sales (POS) of an affiliated store through various wireless communication methods.

Such a conventional in-car payment system relies on a double authentication method through wireless communication between the vehicle and the merchant POS, and wireless communication between an affiliated store and a credit card payment server. With such a method, wireless communication with weak security is passed through several times, and there are concerns for credit card cloning or a server issue of a card company affecting the car payment. In addition, when a failure occurs in the wireless Internet environment, there is a problem that the payment system cannot be used at all.

Further, there are also payment systems based on recognizing a license plate of a car to manage parking. However, since the license plate is exposed to anyone, there is a risk of misappropriation. Further, it is challenging to apply internationally due to the license plates being different from a country or a state to another. In addition, in cold climates, the license plates are often obscured due to heavy snows.

Accordingly, there is a demand for a method for improving the conventional payment system described above.

The above information disclosed in this Background section is only for enhancement of understanding of the background of the present disclosure, and therefore it may contain information that does not constitute prior art.

### SUMMARY

The present disclosure is devised to solve the problems in the related art, and an object of the present disclosure is to solve a problem that the Internet environment is essentially required for a payment system within a transportation means such as cars and the like. Another object of the present disclosure is to improve a conventional vulnerability that an authentication means of a transportation means is exposed to the outside. The objects of the present disclosure are not limited to the aforementioned objects, and other objects, which are not mentioned above, will be apparent to those skilled in the art from the following description.

According to an aspect of the present disclosure, an authentication system may include a light emitter provided in a transportation means, which emits light having a predetermined emission pattern. A light receiver may receive the emission pattern of the light emitted from the light emitter to convert the emission pattern into a predetermined form of data. An authentication server may receive the data converted by the light receiver and may generate authentication information on the data to transmit the generated authentication information to the transportation means.

Further, the authentication system may also include a light discriminator configured to identify light to be converted to the form of data among a plurality of lights received by the light receiver.

The authentication system may further include a light controller configured to control at least one of an emission cadence, an emission duration, an emission interval, a number of emissions, and an emission distance of the light emitted by the light emitter. In some embodiments, the light controller may be provided in the transportation means and may be implemented as an electronic control unit (ECU) configured to execute a control program for controlling light.

Further, the light emission pattern of the light emitted from the light emitter may have a one-time use.

In addition, the light receiver and the authentication server may be provided on a processing institution side that performs an authentication process and/or a payment process by using the authentication information. In some embodiments, the processing institution may be any one of a credit card payment processing entity, a financial institution, a payment service subscriber, or a government institution.

According to another aspect of the present disclosure, an authentication information processing method may include the following Steps (a) to (e).
In Step (a), light having a predetermined emission pattern may be emitted by a light emitter provided in a transportation means.
In Step (b), a light receiver may receive the emission pattern of the light emitted from the light emitter to convert the emission pattern into a predetermined form of data.
In Step (c), the light receiver may transmit the data converted in Step (b) to an authentication server.
In Step (d), the authentication server may generate authentication information on the data transmitted from the light receiver.
In Step (e), the authentication server may then transmit the authentication information to the transportation means.

Further, in Step (a), the emission pattern may be generated by a light controller configured to control at least one of an emission cadence, an emission duration, an emission interval, a number of emissions, and an emission distance of the light emitted by the light emitter.

In some embodiments, before Step (a), the authentication information processing method may further include Step (ex1) of updating a control program for controlling light to be executed by an electronic control unit (ECU) provided in the transportation means.

The authentication information processing method may further include Step (ex2) of identifying, by a light discriminator, the light to be converted into the form of data among a plurality of lights received by the light receiver, between Steps (a) and (b).
In Step (d), the authentication server may recognize and analyze the data based on a predetermined method. Alternatively, in Step (d), the data may be analyzed and decoded based on a machine learning technique.

The authentication information processing method may further include Step (ex3) of performing an authentication process and/or a payment process using the authentication information by a processing institution provided with the light receiver and the authentication server, between Steps (d) and (e).

According to the present disclosure, the authentication system using the light emitter of the transportation means and the authentication information processing method using the same may generate authentication information via the light emitted by the light emitter of the transportation means having a predetermined emission pattern to perform an authentication process or a payment process. Accordingly, the security and safety may be improved compared to conventional authentication systems.

In addition, according to the present disclosure, even if the transportation means is lost or stolen, it is impossible to utilize the transportation means because another person who has obtained the transportation means cannot decrypt an emission pattern or the like. The present disclosure also provides an advantage that the effects of external environments (adverse weather, air pollution, etc.) may be minimized because the user can pay using the light emitter mounted on the transportation means without off-boarding. In addition, the present disclosure may be applied for autonomous driving technologies combined with a machine learning method, and it can be used even in an environment where the Internet is not established.

Unlike in the related art where it is sometimes impossible to check a license plate or identification tag of the transportation means when the distance is long or the illumination is insufficient, the authentication method according to the present disclosure is not affected by such a problem. In addition, whereas in the related art, radio wave communication may be impossible due to radio wave interference, the authentication method according to the present disclosure is not affected by such a problem.

The effects of the present disclosure are not limited to the aforementioned effects, and other effects not mentioned above will be clearly understood by those skilled in the art from the description of the appended claims.

### BRIEF DESCRIPTION OF THE DRAWINGS

FIG. 1 schematically illustrates an authentication system using a light emitter of a transportation means according to a first embodiment of the present disclosure;

FIG. 2 illustrates a process of an authentication information processing method by the authentication system using the light emitter of the transportation means according to the first embodiment of the present disclosure;

FIG. 3 schematically illustrates an authentication system using a light emitter of a transportation means according to a second embodiment of the present disclosure; and

FIG. 4 illustrates a process of an authentication information processing method by the authentication system using the light emitter of the transportation means according to the second embodiment of the present disclosure.

### DETAILED DESCRIPTION

Hereinafter, exemplary embodiments of the present disclosure, with which objects of the present disclosure may be realized, will be described with reference to the accompanying drawings. In describing the embodiments, like labels and like reference numerals will be used with respect to like components, and repeated description will be omitted.

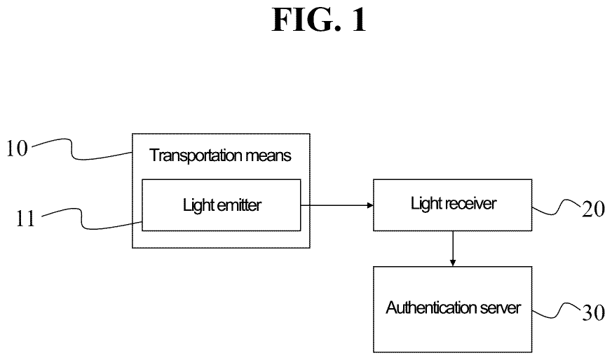

FIG. 1 schematically illustrates an authentication system using a light emitter 11 of a transportation means 10 according to a first embodiment of the present disclosure. As illustrated in FIG. 1, the authentication system according to the first embodiment of the present disclosure may include a light emitter 11 provided in a transportation means 10, a light receiver 20, and an authentication server 30.

The transportation means 10 may encompass any vehicle capable of transporting passengers and/or parcels to another location. For example, the transportation means 10 may include not only a general four-wheeled vehicle, but also a two-wheeled vehicle such as a motorcycle or a bicycle, a ship, an airplane, and furthermore, a spacecraft for navigating in the space.

In addition, the light emitter 11 may emit light having a predetermined emission pattern. For example, in a four-wheeled vehicle, the light emitter 11 may include any lighting devices, without being limited to a particular type, such as a head lamp, a turn signal lamp, a rear lamp, and a laser oscillation lamp. In other words, as long as the light emitter 11 can oscillate (e.g., flicker) the light in a specific or unspecified direction, any type of lamps may be used.

In addition, the emission pattern by the light emitter 11 may be selected from an infinite number of combinations of various factors, such as an emission cadence (e.g., rate of blinking or pulsating), an emission duration, an emission interval, a number of emissions, and an emission distance of the light. Further, the emission pattern of the light emitted from the light emitter 11 may have a one-time use, which may further enhance security by preventing reuse of the emission pattern that has been encrypted and has already been used.

As described above, since the present disclosure utilizes the emission pattern, it is possible to apply not only a binary system but also other notation systems.

The light receiver 20 may receive the emission pattern of the light emitted from the light emitter 11 of the transportation means 10 and may convert the emission pattern into a predetermined data form. As long as the light receiver 20 can recognize the light and convert the emission pattern into data, any light receiver may be used.

In addition, the type of data to be converted by the light receiver 20 is not limited, and may include various types of data forms.

Meanwhile, in order to more effectively recognize the emission pattern of the light emitted from the light emitter 11, the light emitter 11 may additionally emit a predetermined guide pattern before and/or after the emission pattern of the core (e.g., body) of the light.

Such a guide pattern may be recognized as a signal that the emission pattern of the core light is beginning soon or has ended. Accordingly, the light receiver 20 may more easily identify the emission pattern of the core light due to the guide pattern. More specifically, the guide pattern may also be designated as a unique pattern provided differently for each transportation means 10. In this case, in response to the light receiver 20 recognizing the corresponding guide pattern, it may immediately identify unique information of the transportation means 10 that emits the corresponding guide pattern.

In addition, the guide pattern may be randomly selected from a list of a plurality of patterns that do not overlap with the emission patterns in order to distinguish the guide patterns from the light emission patterns of the light emitted from the light emitter 11. Alternatively, the guide pattern may be emitted before and after the emission pattern with a predetermined time interval from the emission pattern of the light, allowing it to be distinguished from the emission pattern of the light.

Further, the emission pattern and the guide pattern of the light may have different wavelength bands. In this case, a plurality of light receivers 20 may be provided to separately recognize wavelengths corresponding to the emission pattern and the guide pattern of light, respectively.

The authentication server 30 may receive the data converted by the light receiver 20, and may generate authentication information associated with the received data and then transmit the authentication information (e.g., authentication result) to the transportation means 10. To this end, a wireless communication unit (not illustrated) or a light receiver for receiving the authentication information may be separately provided in the transportation means 10.

The light receiver 20 and the authentication server 30 may be provided on a processing institution side, which performs the authentication process and/or the payment process using the authentication information. By way of example, the processing institution may include a credit card payment processing entity, a financial institution, a payment service subscriber, or a government institution. In addition, the payment service subscriber may generally include department stores, restaurants, hotels, golf courses, travel agencies, gas stations, and the like.

The authentication system using the light emitter 11 of the transportation means as described above may be applied to a wide range of fields. For example, when the light emitter 11 is implemented as a head lamp of a four-wheeled vehicle, the light emitter 11 may be used for a garage door, a drive-through, a gas station, entry and exit of a parking lot, and information exchange between cars. More specifically, when the present disclosure is applied to the garage door, the emission pattern may be recognized via the light receiver 20 provided at the garage. Subsequently, the authentication server 30 may cause the door to open after generating authentication information thereon.

In addition, when the present disclosure is applied to the drive-through, the gas station, or the entry and exit of the parking lot, the emission pattern of the light may be recognized via the light receiver 20 provided at the site of the corresponding facility. In addition, the authentication server 30 may perform a payment, or may open or close an entrance after generating the authentication information thereon.

When the present disclosure is applied to the information exchange between cars, the emitting pattern of another car may be recognized via the light receiver 20 provided in each car. In addition, the authentication server 30 provided in each car may provide specific information after generating the authentication information thereon. In some implementations, the specific information may be road condition information, such as whether there is an accident in an opposite lane or driving lane, and whether there is a construction.

Hereinafter, an authentication information processing method by the authentication system using the light emitter 11 of the transportation means 10 according to the first embodiment of the present disclosure will be described.

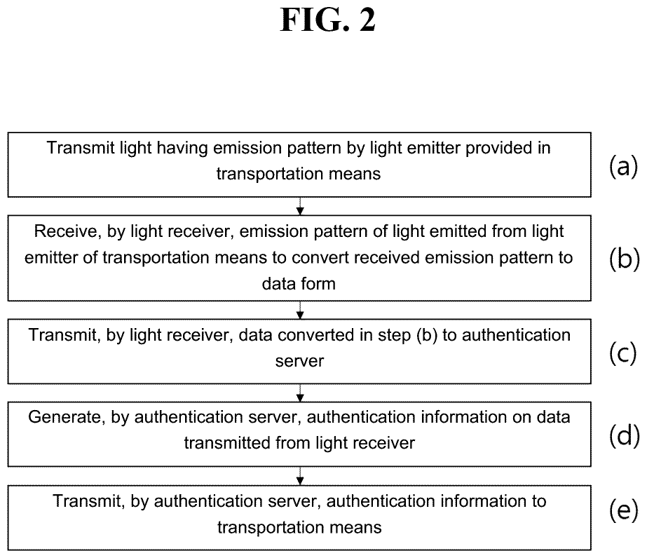

FIG. 2 illustrates a process of an authentication information processing method by the authentication system using the light emitter 11 of the transportation means 10 according to the first embodiment of the present disclosure. As illustrated in FIG. 2, the authentication information processing method by the authentication system using the light emitter 11 of the transportation means 10 according to the first embodiment of the present disclosure may include Steps (a) to (e).
In Step (a), light having a predetermined emission pattern may be emitted by the light emitter 11 provided in the transportation means 10. Here, since the transportation means 10 and the light emitter 11 have already been described above, a detailed description thereof will be omitted. In addition, in Step (a), the emission pattern by the light emitter 11 may be determined from an infinite number of combinations of various factors, such as an emission cadence, an emission duration, an emission interval, a number of emissions, and an emission distance of the light.
In Step (b), the light receiver 20 may receive the emission pattern of the light emitted from the light emitter 11 of the transportation means 10 and may convert the emission pattern into a predetermined data form. Here, the data form converted by the light receiver 20 may include various types of data forms.

Thereafter, in Step (c), the light receiver 20 may transmit the data converted in Step (b) to the authentication server 30.

Accordingly, in Step (d), the authentication server 30 may generate authentication information based on the data transmitted from the light receiver 20.
In Step (e), the authentication server 30 may transmit the authentication information to the transportation means.

Through the process as described above, the authentication server 30 may generate the authentication information to perform an authentication process and/or a payment process.

Hereinafter, another embodiment of the present disclosure will be described.

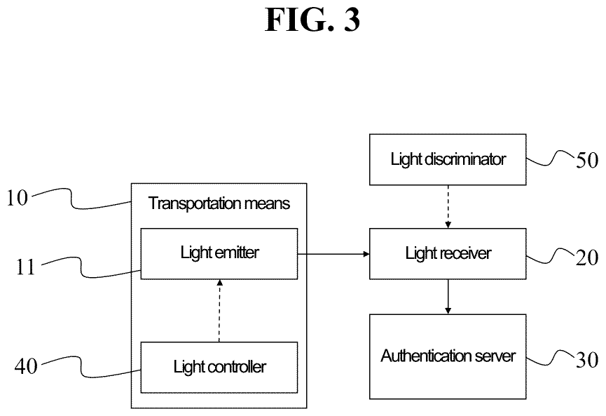

FIG. 3 schematically illustrates an authentication system using a light emitter 11 of a transportation means 10 according to a second embodiment of the present disclosure. As illustrated in FIG. 3, the second embodiment may include a light emitter 11 provided in a transportation means 10, a light receiver 20, and an authentication server, like the first embodiment described above. In addition, the present embodiment may further include a light controller 40 and a light discriminator 50.

The light controller 40 may control at least one of an emission cadence, an emission duration, an emission interval, a number of emissions, and an emission distance of the light emitted by the light emitter 11. The light controller 40 may be a light control means separately provided in the transportation means 10. Alternatively, the light controller 40 may be provided in the transportation means 10 and may be integrated with an electronic control unit (ECU), which may be configured to execute a control program for controlling the light.

The light discriminator 50 may identify only the light to be converted into a data form from among the plurality of lights received by the light receiver 20. More particularly, the light discriminator 50 may separately recognize a meaningful emission pattern, that is, the light emitted by the transportation means 10 from various lights emitted from places other than the transportation means 10. In addition, the light discriminator 50 may separately recognize a meaningful emission pattern, that is, the light to be converted into a data form among various lights emitted from lighting devices of the transportation means 10.

Hereinafter, an authentication information processing method by the authentication system using the light emitter of the transportation means according to the second embodiment of the present disclosure will be described.

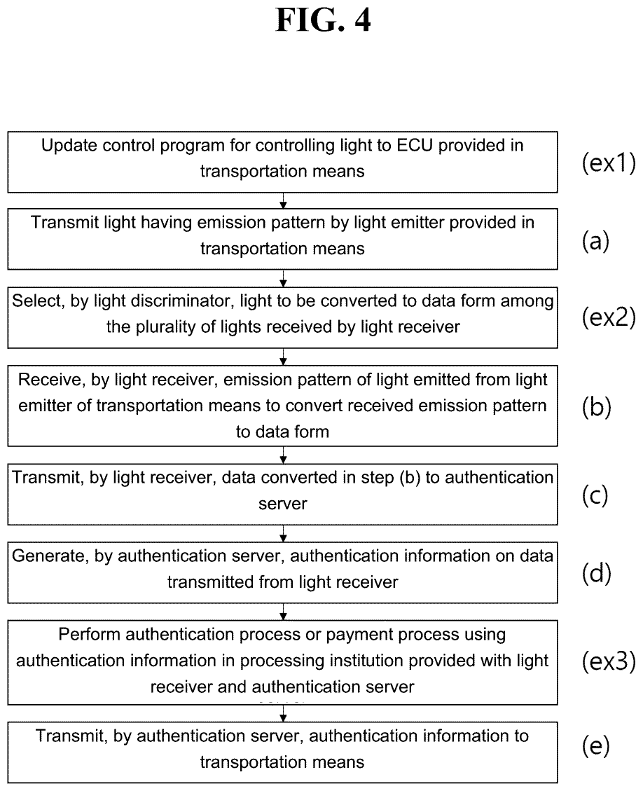

FIG. 4 illustrates a process of an authentication information processing method by the authentication system using the light emitter 11 of the transportation means 10 according to the second embodiment of the present disclosure. As illustrated in FIG. 4, the authentication information processing method according to the second embodiment of the present disclosure may include Steps (ex1) to (ex3) in addition to the previously described Steps (a) to (e).

More particularly, in Step (a), light having a predetermined emission pattern may be emitted by the light emitter 11 provided in the transportation means 10. In Step (a), the emission pattern may be generated by the light controller 40 configured to control at least one of an emission cadence, an emission duration, an emission interval, a number of emissions, and an emission distance of the light emitted by the light emitter 11.

As described above, the light controller 40 may be separately provided in the transportation means 10. Alternatively, the light controller 40 may be provided in the transportation means 10 and may be implemented as an electronic control unit (ECU), which is configured to execute a control program for controlling light.

Prior to Step (a), Step (ex1) of updating a control program for controlling light in the ECU provided in the transportation means 10 may be further performed.

In addition, in Step (b), the light receiver 20 may receive the emission pattern of the light emitted from the light emitter 11 of the transportation means 10 and may convert the emission pattern into a predetermined data form.

Between Steps (a) and (b) in the present embodiment, Step (ex2) in which the light discriminator 50 identifies the light to be converted into a data form among a plurality of lights received by the light receiver 20 may be further performed. More specifically, in Step (ex2), the light discriminator 50 may recognize a meaningful emission pattern, that is, the light emitted from the transportation means 10 among various lights emitted from places other than the transportation means 10. In addition, in Step (ex2), the light discriminator 50 may recognize a meaningful emission pattern, that is, the light to be converted into a data form among various lights emitted from lighting devices of the transportation means 10.

Thereafter, in Step (c), the light receiver 20 may transmit the data converted in Step (b) to the authentication server 30. Accordingly, in Step (d), the authentication server 30 may generate authentication information on the data transmitted from the light receiver 20. For Step (d), a method in which the authentication server 30 recognizes and analyzes data based on a predetermined algorithm may be applied. Alternatively, in Step (d), a method of analyzing and decoding data based on a machine learning technique may be applied. Subsequently, in Step (e) the authentication server 30 may transmit the authentication information to the transportation means.

Between Steps (d) and (e), Step (ex3) of performing an authentication process and/or a payment process using the authentication information may be further performed by a processing institution provided with the light receiver 20 and the authentication server 30.

Through the process as described above, the authentication server 30 may generate the authentication information to perform the authentication process or the payment process.

Meanwhile, in Step (ex3), the authentication process or the payment process may be performed using the authentication information in the processing institution provided with the light receiver 20 and the authentication server 30, and the authentication server 30 may determine the authentication process or payment process based on whether the transportation means 10 is proximate to a portable terminal (e.g., a smart phone) of a driver or a passenger. For example, in response to determining that the transportation means 10 and the portable terminal of the driver/passenger are present within a predetermined distance from each other, the authentication process or payment process may be performed (e.g., successful authentication).

On the contrary, in response to determining that the transportation means 10 and the portable terminal of the driver/passenger are not present within a predetermined distance from each other, the authentication process or payment process may not be performed (e.g., authentication failure). This is because when the portable terminal of the driver/passenger is not proximate to the transportation means 10, it may be determined that there is no authorization of payment or intent to pay from the driver/passenger.

In addition, in order to determine the distance between the transportation means 10 and the portable terminal of the driver/passenger, a GPS provided in the transportation means 10 and GPS coordinate data transmitted from the GPS of the transportation means 10 may be used.

In addition, whether the light emitter 11 and the light receiver 20 are close to each other may also be a factor in allowing the authentication process or payment process.

As described above, the exemplary embodiments of the present disclosure have been described, and in addition to the embodiments described above, it may be apparent that the present disclosure can be materialized in other specific forms without departing from the gist or scope of the present disclosure to those skilled in the art. Therefore, the aforementioned embodiments are not limiting but should be considered to be illustrative, and accordingly, the present disclosure is not limited to the above description and may be modified within the scope of the appended claims and a range equivalent thereto.

What is claimed is:

1. An authentication system comprising:
a light emitter, provided in a transportation means, that emits light having a predetermined emission pattern;
a light receiver that receives the emission pattern of the light emitted from the light emitter to convert the emission pattern into a predetermined form of data; and
an authentication server that receives the data converted by the light receiver and generates authentication information on the data to transmit the generated authentication information to the transportation means.

2. The authentication system of claim 1, further comprising:
a light discriminator configured to identify light to be converted to the form of data among a plurality of lights received by the light receiver.

3. The authentication system of claim 1, further comprising:
a light controller configured to control at least one of an emission cadence, an emission duration, an emission interval, a number of emissions, and an emission distance of the light emitted by the light emitter.

4. The authentication system of claim 3, wherein the light controller is provided in the transportation means and is implemented as an electronic control unit (ECU) configured to execute a control program for controlling the light.

5. The authentication system of claim 1, wherein the light emission pattern of the light emitted from the light emitter has a one-time use.

6. The authentication system of claim 1, wherein the light receiver and the authentication server are provided on a processing institution side that performs an authentication process and/or a payment process using the authentication information.

7. The authentication system of claim 1, wherein the processing institution is any one of a credit card payment processing entity, a financial institution, a payment service subscriber, or a government institution.

8. An authentication information processing method, comprising:
(a) emitting, by a light emitter provided in a transportation means, light that has a predetermined emission pattern;
(b) receiving, by a light receiver, the emission pattern of the light emitted from the light emitter to convert the emission pattern into a predetermined form of data;
(c) transmitting, by the light receiver, the data converted by the light receiver to an authentication server;
(d) generating, by the authentication server, authentication information on the data transmitted from the light receiver; and
(e) transmitting, by the authentication server, the authentication information to the transportation means.

9. The authentication information processing method of claim 8, wherein in Step (a), the emission pattern is generated by a light controller configured to control at least one of an emission cadence, an emission duration, an emission interval, a number of emissions, and an emission distance of the light emitted by the light emitter.

10. The authentication information processing method of claim 9, further comprising, before Step (a):
(ex1) updating a control program for controlling the light to be executed in an electronic control unit (ECU) provided in the transportation means.

11. The authentication information processing method of claim 8, further comprising, between Steps (a) and (b):
(ex2) identifying, by a light discriminator, the light to be converted into the form of data among a plurality of lights received by light receiver.

12. The authentication information processing method of claim 8, wherein in Step (d), the authentication server recognizes and analyzes the data based on a predetermined method.

13. The authentication information processing method of claim 8, wherein in Step (d), the data is analyzed and decoded based on a machine learning technique.

14. The authentication information processing method of claim 8, further comprising, between Steps (d) and (e):
(ex3) performing an authentication process and/or a payment process using the authentication information by a processing institution provided with the light receiver and the authentication server.
